(19) United States
(12) Patent Application Publication
(10) Pub. No.: US 2026/0322289 A1
(43) Pub. Date: Oct. 15, 2026

(54) POWER CONVERSION DEVICE

(71) Applicant: HITACHI ASTEMO, LTD., Hitachinaka-shi, Ibaraki (JP)

(72) Inventors: Koichi YAHATA, Hitachinaka-shi, Ibaraki (JP); Trong Tao BUI, Hitachinaka-shi, Ibaraki (JP); Takayuki SASANUMA, Hitachinaka-shi, Ibaraki (JP); Hayato NIHEI, Hitachinaka-shi, Ibaraki (JP)

(73) Assignee: HITACHI ASTEMO, LTD., Hitachinaka-shi, Ibaraki (JP)

(21) Appl. No.: 19/111,158

(22) PCT Filed: Sep. 15, 2022
(86) PCT No.: PCT/JP2022/034627

§ 371 Date: Mar. 12, 2025

(51) Int. Cl. H02M 7/5387; H02M 1/00; H02M 1/088; H02M 1/32

(52) U.S. Cl. CPC H02M 7/53871; H02M 1/0009; H02M 1/0054; H02M 1/088; H02M 1/32

(57) ABSTRACT

There is provided a power conversion device including: an inverter circuit configured by connecting switching elements of an upper arm and a lower arm in series; an output current detector that outputs a detection value of an AC current output from a connection point between the switching elements of the upper arm and the lower arm; a driver circuit that drives each of the switching elements by a drive signal via a switched gate resistor; an overcurrent detection circuit that compares the detection value with any of a plurality of predetermined overcurrent threshold values and outputs an overcurrent detection signal in a case where the detection value is more than the overcurrent threshold value; and a controller that transmits the drive signal, transmits a gate resistor switching signal for switching the gate resistor to the driver circuit, and transmits an overcurrent threshold-value switching signal for switching the overcurrent threshold value, in which the controller sets the overcurrent threshold value to a small value by the overcurrent threshold-value switching signal in a case where the controller switches to the gate resistor having a lower resistance value by the gate resistor switching signal.

### TECHNICAL FIELD

The present invention relates to a power conversion device.

### BACKGROUND ART

A power conversion device that converts DC power into AC power includes arms corresponding to a plurality of phases, each arm being configured by connecting a switching element of an upper arm and a switching element of a lower arm in series. The switching element is driven by a drive signal input through a gate resistor connected to a gate of the switching element.

Generally, a switching loss occurs in a switching element due to energization. However, a switching speed of the switching element is increased by switching the gate resistor in accordance with an operation condition of the switching element such as an applied voltage or current, thereby reducing the loss of the switching element. On the other hand, when the switching element is turned off, a surge voltage is generated in proportion to a decreasing speed of a collector current.

PTL 1 discloses a power conversion device that changes a gate resistor under a condition that a surge voltage increases.

### CITATION LIST

### Patent Literature

PTL 1: JP 2016-059089 A

### SUMMARY OF INVENTION

### Technical Problem

In the technique disclosed in PTL 1, in a case where a motor current rapidly increases due to some abnormality in a state where the resistance value of the gate resistor is lowered, the switching element may fail due to the surge voltage, and the reliability of the power conversion device decreases.

### Solution to Problem

According to the present invention, a power conversion device includes: an inverter circuit including arms corresponding to a plurality of phases, each arm being configured by connecting a switching element of an upper arm and a switching element of a lower arm in series between a positive side terminal and a negative side terminal of a direct current; an output current detector that detects an AC current output from a connection point between the switching element of the upper arm and the switching element of the lower arm and outputs a detection value; a driver circuit that includes a gate resistor switching circuit that switches a gate resistor connected to a gate of each of the switching elements, and drives each of the switching elements by a drive signal input via the switched gate resistor; an overcurrent detection circuit that compares the detection value detected by the output current detector with any of a plurality of predetermined overcurrent threshold values, and outputs an overcurrent detection signal in a case where the detection value is more than the overcurrent threshold value; and a controller that transmits the drive signal to the driver circuit, transmits a gate resistor switching signal for switching the gate resistor to the driver circuit, and transmits an overcurrent threshold-value switching signal for switching the overcurrent threshold value to the overcurrent detection circuit. The controller sets the overcurrent threshold value to a small value by the overcurrent threshold-value switching signal in a case where the controller switches to the gate resistor having a low resistance value by the gate resistor switching signal.

### Advantageous Effects of Invention

According to the present invention, it is possible to improve the reliability of a power conversion device even in a case where the resistance value of a gate resistor is lowered.

### BRIEF DESCRIPTION OF DRAWINGS

FIG. 1 is an overall configuration diagram of a power conversion device in a first embodiment.

FIG. 2 is a detailed configuration diagram of a main part of the power conversion device in the first embodiment.

FIG. 3(a) and 3(B) are graphs showing switching of a collector-emitter voltage and a gate resistor of a switching element, and a relationship between an overcurrent threshold value and an AC current.

FIG. 4 is a detailed configuration diagram of a main part of a power conversion device in a second embodiment.

FIG. 5 is a detailed configuration diagram of a main part of a power conversion device in a third embodiment.

Hereinafter, embodiments of the present invention will be described with reference to the drawings. The following description and drawings are examples for describing the present invention, and will be omitted and simplified as appropriate for the sake of clarity of description. The present invention can be carried out in various other forms. Unless otherwise specified, each component may be singular or plural.

### First Embodiment

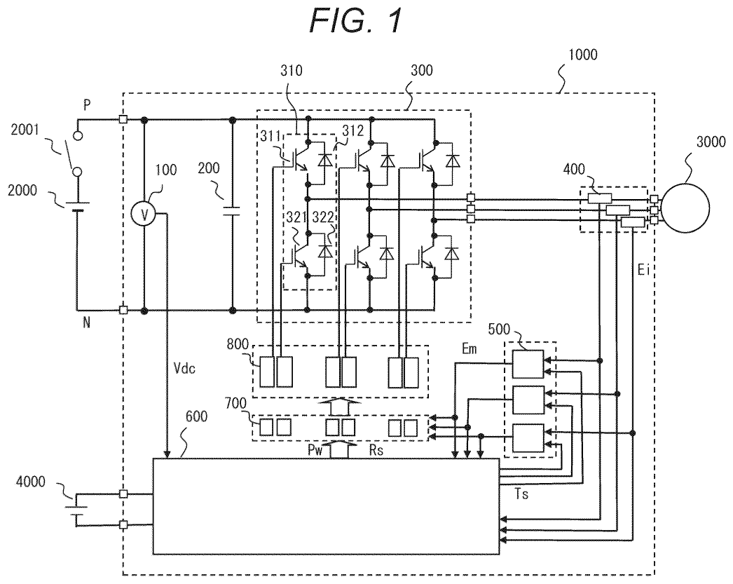

FIG. 1 is an overall configuration diagram of a power conversion device 1000 in a first embodiment.

The power conversion device 1000 converts DC power supplied from a DC power source 2000 such as a battery into AC power and drives a motor 3000. The DC power source 2000 supplies DC power between a positive side terminal P and a negative side terminal N of the power conversion device 1000 via a contactor 2001. The motor 3000 is, for example, a three-phase induction motor, and is used as a drive source of a vehicle.

The power conversion device 1000 includes a voltage detector 100 that is connected in parallel between the positive side terminal P and the negative side terminal N and detects a DC voltage between the positive side terminal P and the negative side terminal N, a capacitor module 200 that smooths the DC current, and an inverter circuit 300 that performs power conversion. The power conversion device 1000 further includes an output current detector 400, an overcurrent detection circuit 500, a controller 600, a cut-off circuit 700, and a driver circuit 800.

The inverter circuit 300 includes a power module 310 having an upper and lower arm series circuit that includes a switching element 311 and a diode 312 which operate as an upper arm and a switching element 321 and a diode 322 which operate as a lower arm. The power module 310 is provided for three phases (U-phase, V-phase, and W-phase) corresponding to the respective phase windings of the motor 3000. That is, the inverter circuit 300 includes arms corresponding to the three phases. Each of the arms is configured by connecting the switching element 311 of the upper arm and the switching element 321 of the lower am in series between the positive side terminal P and the negative side terminal N of the direct current. Here, an example of three phases will be described, but for example, a configuration including the power modules 310 corresponding to a plurality of phases, in accordance with the number of phases of the motor 3000, may be made.

The output current detector 400 detects an AC current output from a connection point between the switching element of the upper arm and the switching element of the lower arm for each phase, and outputs each detection value Ei to the overcurrent detection circuit 500 and the controller 600. The detection value Ei represents the magnitude of the detected AC current by a voltage value.

The overcurrent detection circuit 500 is provided for each phase, and outputs an overcurrent detection signal Em to the controller 600 and the cut-off circuit 700 in a case where the detection value of the AC current is more than an overcurrent threshold value. Details of the overcurrent detection circuit 500 will be described later.

In the controller 600, a low-voltage power source 4000 is connected from the outside of the power conversion device 1000, and a low voltage is supplied from the low-voltage power source 4000 in a state where an ignition key of the vehicle is turned on. A drive signal Pw is output to the driver circuit 800 via the cut-off circuit 700 in accordance with a torque command from a higher controller (not illustrated), a detection voltage Vdc from the voltage detector 100, the detection value Ei from the output current detector 400, and the overcurrent detection signal Em from the overcurrent detection circuit 500. In addition, the controller 600 outputs an overcurrent threshold-value switching signal Ts to the overcurrent detection circuit 500. Further, a gate resistor switching signal Rs for switching a gate resistor in accordance with a detection value from the output current detector 400 is transmitted to the driver circuit 800. Details of the controller 600 will be described later.

The cut-off circuit 700 is provided corresponding to the driver circuit 800, and cuts off the drive signal Pw from the controller 600 to the switching elements 311 and 321 in response to the overcurrent detection signal Em output from the overcurrent detection circuit 500. Details of the cut-off circuit 700 will be described later.

The driver circuit 800 is provided corresponding to each of the switching elements 311 and 321. The driver circuit 800 includes a gate resistor switching circuit that switches a gate resistor connected to a gate of each of the switching elements 311 and 321, and drives the switching elements 311 and 321 by the drive signal Pw input via the switched gate resistor. Details of the driver circuit 800 will be described later.

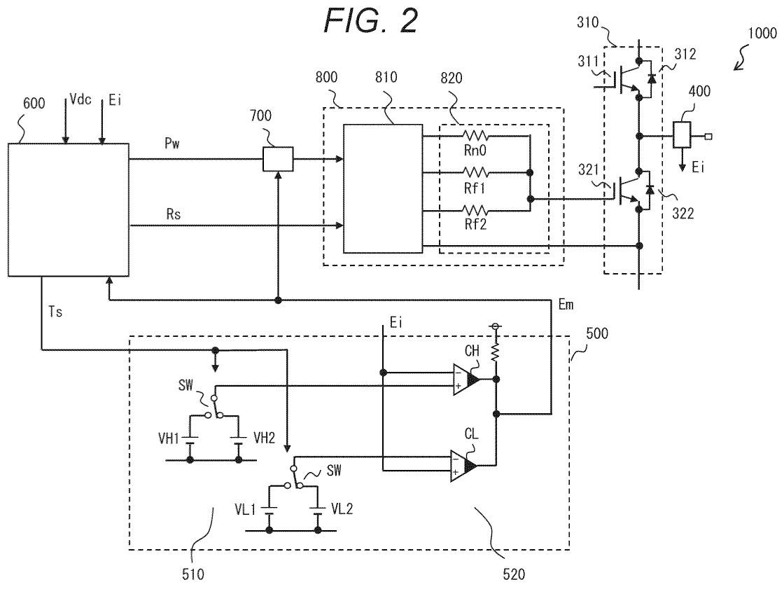

FIG. 2 is a detailed configuration diagram of a main part of the power conversion device 1000 in the first embodiment. In this drawing, the overcurrent detection circuit 500 corresponding to the power module 310 for one phase, and the cut-off circuit 700 and the driver circuit 800 corresponding to the switching element 321 of the lower arm of the power module 310 for one phase are illustrated. That is, although not illustrated, the cut-off circuit 700 and the driver circuit 800 corresponding to the switching element 311 of the upper arm of the power module 310 for one phase have the same configurations as those of the cut-off circuit 700 and the driver circuit 800 corresponding to the switching element 321 of the lower arm, Further, the overcurrent detection circuits 500 corresponding to the power modules 310 of the other phases, and the cut-off circuits 700 and the driver circuits 800 corresponding to the switching elements 311 and 321 of the power modules 310 for the other phases also have the same configurations as those in FIG. 2.

The detection value Ei from the output current detector 400 is input to the overcurrent detection circuit 500 and the controller 600. The detection voltage Vdc from the voltage detector 100 is input to the controller 600.

The controller 600 transmits the drive signal Pw to the driver circuit 800 via the cut-off circuit 700. In addition, the gate resistor switching signal Rs for switching the gate resistance is transmitted to the driver circuit 800. The drive signal Pw is a PWM signal. The cut-off circuit 700 cuts off the drive signal Pw immediately in a case where the overcurrent detection signal Em, which will be described in more detail later, is input from the overcurrent detection circuit 500. As a result, driving of the switching element 321 by the driver circuit 800 is stopped.

The driver circuit 800 includes a drive circuit 810 and a gate resistor switching circuit 820. The gate resistor switching circuit 820 switches gate resistors Rf1 and Rf2 connected to the gate of the switching element 321 by the gate resistor switching signal Rs. A gate resistor Rn0 is a resistor connected in a case where the switching element 321 is turned on. The gate resistors Rf1 and Rf2 are resistors connected in a case where the switching element 321 is turned off, and the resistance value of the gate resistor Rf1 is lower than the resistance value of the gate resistor Rf2. In response to the input of the gate resistor switching signal Rs, the resistance when the switching element 321 is turned off is switched to the gate resistor Rf1.

In general, a switching loss occurs in the switching element 321, which causes a decrease in efficiency of the inverter circuit 300, and in turn, a cruising distance of the vehicle. Therefore, by switching to the gate resistor Rf1 having a low resistance value in a case where the switching element 321 is turned off, depending on an operation condition of the switching element 321 such as voltage and a current, the switching speed is increased, and thus the switching loss of the switching element 321 is reduced. Specifically, in a case where a DC voltage, which is the detection voltage Vdc detected by the voltage detector 100, is low and the output current detector 400 detects that the current flowing through the motor 3000 is low, an allowable surge voltage increases. In this case, by switching to the gate resistor Rf1 having a low resistance value, the switching speed is further increased, and thus the switching loss is reduced.

However, in a case where the current flowing through the motor 3000 rapidly increases due to some abnormality in a state where the resistance value of the gate resistor is lowered, the switching element 321 may fail due to the surge voltage. Therefore, in a case where switching to the gate resistor Rf1 having a low resistance value is performed, the controller 600 transmits an overcurrent threshold-value switching signal Ts to the overcurrent detection circuit 500, which will be described later, and sets the overcurrent threshold value to a small value. That is, the controller 600 outputs the overcurrent threshold-value switching signal Ts at substantially the same timing when switching to the gate resistor Rf1 is performed by the gate resistor switching signal Rs, and sets the overcurrent threshold value of the overcurrent detection circuit 500 to a small value. As a result, the failure of the switching element 321 is prevented, and the reliability of the power conversion device 1000 is improved even in a case where the resistance value of the gate resistor is lowered.

As illustrated in FIG. 2, the overcurrent detection circuit 500 includes a threshold-value switching unit 510 and a comparison unit 520. The threshold-value switching unit 510 switches the threshold value to overcurrent threshold values VH1 and VL1, or overcurrent threshold values VH2 and VL2 by a switch SW. Specifically, the switch SW is operated by the overcurrent threshold-value switching signal Is from the controller 600, and the overcurrent threshold values VH1 and VL1 are selected. When the overcurrent threshold-value switching signal Ts is not provided, the overcurrent threshold values VH2 and VL2 are selected. The unit of the threshold value is a voltage, and a relationship of the overcurrent threshold value VH1<the overcurrent threshold value VH2 and the overcurrent threshold value VL1<the overcurrent threshold value VL2 is satisfied. The overcurrent threshold values VH1, VL1, VH2, and VL2 are supplied from a plurality of power sources having different voltage values.

The comparison unit 520 includes a comparator CH that compares the detection value Ei from the output current detector 400 with the overcurrent threshold value VH1 or the overcurrent threshold value VH2, and a comparator CL that compares the detection value Ei with the overcurrent threshold value VL1 or the overcurrent threshold value VL2. The comparison unit 520 outputs the overcurrent detection signal Em in accordance with the comparison result. In a case where the overcurrent threshold-value switching signal Ts is not provided and the overcurrent threshold values VH2 and VL2 are selected, the overcurrent detection signal Em is not output when the detection value Ei is within a range of the overcurrent threshold values VH2 and VL2. When the detection value Ei exceeds the range of the overcurrent threshold values VH2 and VL2, the overcurrent detection signal Em is output. In a case where the overcurrent threshold values VH1 and VL1 are selected by the overcurrent threshold-value switching signal Ts, the overcurrent detection signal Em is not output when the detection value Ei is within a range of the overcurrent threshold values VH1 and VL1. When the detection value Ei exceeds the range of the overcurrent threshold values VH1 and VL1, the overcurrent detection signal Em is output. The overcurrent detection signal Em is input to the controller 600 and the cut-off circuit 700.

The overcurrent threshold values VH2 and VL2 are set to values indicating a current value at which the voltage applied to the switching element 321 does not exceed the allowable value of the switching element 321 in a case where the switching element 321 is driven at the resistance value of the gate resistor Rf2. In addition, the overcurrent threshold values VH1 and VL1 are set to values indicating a current value at which the voltage applied to the switching element 321 does not exceed the allowable value of the switching element 321 in a case where the switching element 321 is driven at the resistance value of the gate resistor Rf1.

In a case where the overcurrent detection signal Em is input, the controller 600 performs control to prevent the overcurrent of the motor 3000, such as stopping the output of the drive signal Pw. Since the overcurrent detection signal Em is also input to the cut-off circuit 700, the drive signal Pw can be immediately cut off instead of waiting for the controller 600 to stop the output of the drive signal Pw.

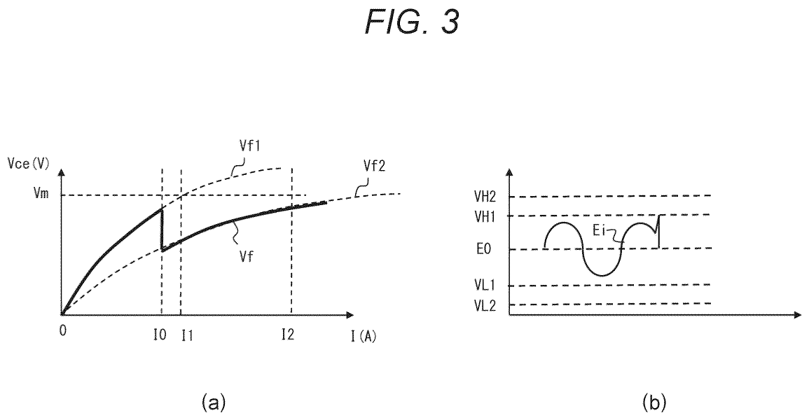

FIG. 3(a) is a graph showing a relationship between a voltage Vce applied between the collector and the emitter of the switching element 321 and a current value I detected by the output current detector 400. The horizontal axis represents the current value I, and the vertical axis represents the voltage Vce. FIG. 3(B) is a graph showing a relationship between the overcurrent threshold value and the detection value Ei of the AC current. The horizontal axis represents the time, and the vertical axis represents the voltage.

Normally, when the switching element 321 is turned off, the voltage Vce applied between the collector and the emitter of the switching element 321 increases as the current flowing through the switching element 321 increases. In addition, regarding the magnitude, the degree of increase is large in a case where the switching speed is high. Furthermore, the switching speed at turn-off is inversely proportional to the magnitude of the resistance value of the gate resistor, and tends to be slow in a case where the resistance value is high and be fast in a case where the resistance value is low. Therefore, the surge voltage is reduced in a case where the resistance value is high, and the surge voltage is increased in a case where the resistance value is low.

On the other hand, in a case where the switching speed is high, the switching loss of the switching element 321 can be reduced. Thus, by lowering the resistance value of the gate resistor in a low current region, it is possible to reduce the loss while suppressing the surge voltage to be equal to or less than the allowable value.

In FIG. 3(a), a current value for switching to the gate resistor Rf1 having a low resistance value is set as I0, an overcurrent detection level in the gate resistor Rf1 having a low resistance value is set as I1, and an overcurrent detection level in the gate resistor Rf2 having a high resistance value is set as I2. Vm is an allowable breakdown voltage of the switching element 321.

The graph illustrated in FIG. 3(a) illustrates an example in which, based on the detection value Ei from the output current detector 400, the controller 600 switches to the gate resistor Rf2 in a case where the current value I is more than the current value I0 and switches to the gate resistor Rf1 in a case where the current value I is equal to or less than the current value I0.

Here, a case where the gate resistor Rf2 remains without switching the gate resistance regardless of the current value I will be considered. In this case, as indicated by a dotted line Vf2 in FIG. 3(a), the voltage Vce applied to the switching element 321 gradually increases as the current increases from 0 (A) to I0 (A), I1 (A), and I2 (A).

However, in a case where the motor 3000 or the like is in some abnormal state, and the current rapidly increases to exceed the maximum current, the voltage Vce applied to the switching element 321 exceeds the allowable breakdown voltage Vm, and the switching element 321 may fail. In preparation for this case, the overcurrent threshold values VH2 and VL2 are set. The overcurrent threshold values VH2 and VL2 correspond to the overcurrent detection level I2. When the current reaches the overcurrent detection level I2, the controller 600 prevents an increase in the current flowing through the motor 3000 by control such as stopping the transmission of the PWM signal, and performs control such that the voltage Vce applied to the switching element 321 does not exceed the allowable breakdown voltage Vm.

On the other hand, in a case where the gate resistors Rf1 and Rf2 are switched, the switching speed of the switching element 321 is increased by switching to the gate resistor Rf1 having a low resistance value in the low current region where the current is equal to or less than I0. Here, in a case where the overcurrent state has suddenly occurred in a state of the low gate resistor Rf1, the degree of increase in the surge voltage is larger than that when the resistance value is high. Therefore, if the overcurrent detection level remains at I2, the voltage Vce exceeds the allowable breakdown voltage Vm in a case where the current is larger than I1, as indicated by a dotted line Vf1 in FIG. 3(a).

In the present embodiment, in a case where the gate resistance is set to a low value, the overcurrent detection level is set to the overcurrent detection level I1 lower than I2. The overcurrent detection level I1 corresponds to the overcurrent threshold values VH1 and VL1. This is a value at which the voltage applied to the switching element 321 does not exceed the allowable value of the switching element 321 in a case where the switching element 321 is driven by the gate resistor Rf1. As indicated by a thick solid line Vf in FIG. 3(a), the overcurrent detection level is set to the overcurrent detection level I1 in a state where switching to the low gate resistor Rf1 is performed, and is set to the overcurrent detection level I2 in a state where switching to the high gate resistor Rf2 is performed.

As illustrated in FIG. 3(b), when the detection value Ei from the output current detector 400 exceeds the range of the overcurrent threshold values VH1 and VL1 in the state of switching to the low gate resistor Rf1, the overcurrent detection circuit 500 detects this and outputs the overcurrent detection signal Em.

As a result, even in a case where the resistance value of the gate resistor is switched and the switching speed of the switching element 321 is increased, it is possible to prevent the failure of the switching element 321 and improve the reliability of the power conversion device 1000.

Note that, in this example, the case where the gate resistor is switched in two stages has been described, but a configuration in which the gate resistor may be switched in a plurality of stages such as three or more stages. In this case, the gate resistor switching circuit 820 performs switching among a plurality of gate resistors, and the overcurrent detection circuit 500 performs switching among a plurality of overcurrent threshold values in accordance with the switched gate resistor.

### Second Embodiment

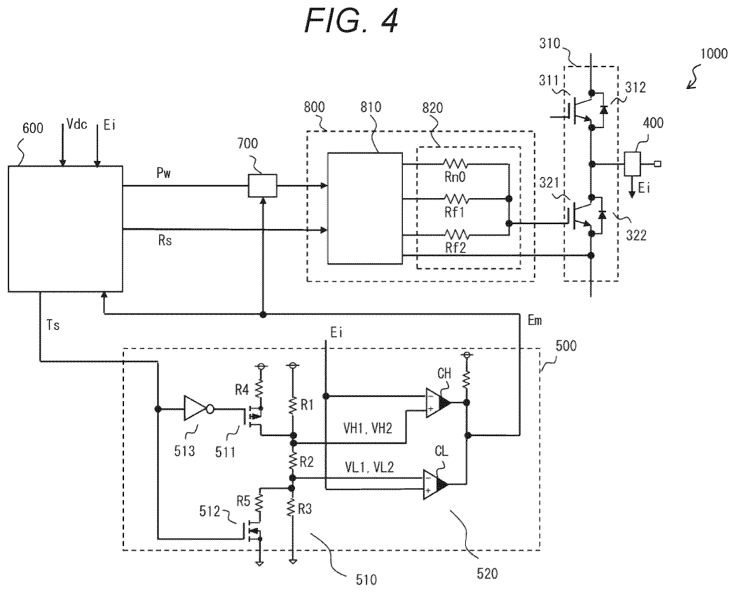

FIG. 4 is a detailed configuration diagram of a main part of a power conversion device 1000 in a second embodiment. In this drawing, similarly to FIG. 2, an overcurrent detection circuit 500 corresponding to a power module 310 for one phase, and a cut-off circuit 700 and a driver circuit 800 corresponding to a switching element 321 of the lower arm of the power module 310 for one phase are illustrated. The same portions as those in FIG. 2 are denoted by the same reference signs, and the description thereof will be simplified. An overall configuration diagram of the power conversion device 1000 is similar to that of FIG. 1.

The second embodiment is different from the first embodiment in the configuration of the overcurrent detection circuit 500.

As illustrated in FIG. 4, the overcurrent detection circuit 500 includes a threshold-value switching unit 510 and a comparison unit 520. Similarly to FIG. 2, the comparison unit 520 includes a comparator CH that compares the detection value Ei from the output current detector 400 with the overcurrent threshold value VH1 or the overcurrent threshold value VH2, and a comparator CL that compares the detection value Ei with the overcurrent threshold value VL1 or the overcurrent threshold value VL2. The comparison unit 520 outputs the overcurrent detection signal Em in accordance with the comparison result.

The threshold-value switching unit 510 includes resistors R1, R2, and R3 connected in series to a reference power source, a resistor R4 connected in parallel with the resistor R1 via a FET 511, and a resistor R5 connected in parallel with the resistor R3 via a FET 512. A plurality of overcurrent threshold values are supplied by dividing a voltage from a single power source. At a low level at which an overcurrent threshold-value switching signal Ts is not output from a controller 600, the FET 511 via a NOT gate 513 and the FET 512 that does not pass through a NOT gate 513 are in an off state. In this case, an overcurrent threshold value VH2 divided by the resistors R1, R2, and R3 is input to a comparator CH, and an overcurrent threshold value VL2 is input to a comparator CL. At a high level at which the overcurrent threshold-value switching signal Ts is output from the controller 600, the FETs 511 and 512 are turned on, so that the resistor R4 is connected to the resistor R1 and the resistor R5 is connected to the resistor R3 in parallel, and thus the resistance value decreases. Therefore, an overcurrent threshold value VH1 is input to the comparator CH, and an overcurrent threshold value VL1 is input to the comparator CL.

In a case where switching to the gate resistor having a low resistance value is performed by a gate resistor switching signal Rs, the controller 600 sets an overcurrent threshold value to a small value by the overcurrent threshold-value switching signal Ts. Thus, in a case where the overcurrent detection signal Em is input, the controller 600 performs control to prevent the overcurrent of the motor 3000, such as stopping the output of the drive signal Pw.

According to the present embodiment, even in a case where the resistance value of the gate resistor is switched, and the switching speed of the switching element 321 is increased, it is possible to prevent a failure of the switching element 321 and improve the reliability of the power conversion device 1000. In addition, it is possible to simplify the configuration of the overcurrent detection circuit 500.

### Third Embodiment

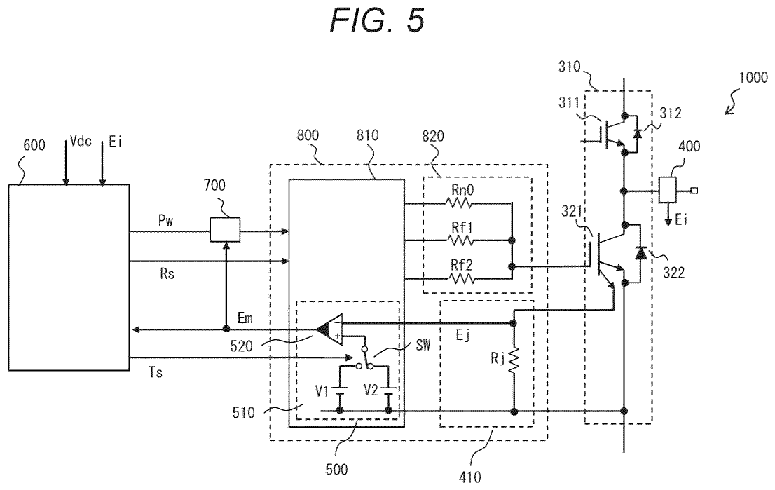

FIG. 5 is a detailed configuration diagram of a main part of a power conversion device 1000 in a third embodiment. In this drawing, a cut-off circuit 700 and a driver circuit 800 corresponding to a switching element 321 of the lower arm of a power module 310 for one phase are illustrated. An overcurrent detection circuit 500 is provided in a driver circuit 800. The same portions as those in FIG. 2 are denoted by the same reference signs, and the description thereof simplified. An overall configuration diagram of the power conversion device 1000 is similar to that of FIG. 1.

The third embodiment is different from the first embodiment in the configuration of the output current detection circuit 410 and the overcurrent detection circuit 500.

As illustrated in FIG. 5, the switching element 321 includes a current sense terminal that divides a current flowing through the switching element 321. The output current detection circuit 410 converts the divided current into a voltage value by a sense resistor Rj and outputs the voltage as a detection value Ej to the overcurrent detection circuit 500.

The overcurrent detection circuit 500 includes a threshold-value switching unit 510 and a comparison unit 520. In the threshold-value switching unit 510, an overcurrent threshold value V2 is selected by a switch SW in a case where an overcurrent threshold-value switching signal Ts from the controller 600 is not provided, and an overcurrent threshold value V1 is selected in a case where the overcurrent threshold-value switching signal Ts is provided. A relationship of the overcurrent threshold value V1<the overcurrent threshold value V2 is satisfied. The comparison unit 520 compares the detection value Ej from the output current detection circuit 410 with the overcurrent threshold value V1 or the overcurrent threshold value V2, and outputs an overcurrent detection signal Em in accordance with the comparison result.

In a case where switching to the gate resistor having a low resistance value is performed by a gate resistor switching signal Rs, the controller 600 sets an overcurrent threshold value to a small value by the overcurrent threshold-value switching signal Ts. Thus, in a case where the overcurrent detection signal Em is input, the controller 600 performs control to prevent the overcurrent of the motor 3000, such as stopping the output of the drive signal Pw.

According to the present embodiment, even in a case where the resistance value of the gate resistor is switched, and the switching speed of the switching element 321 is increased, it is possible to prevent a failure of the switching element 321 and improve the reliability of the power conversion device 1000. In addition, it is possible to simplify the configuration of the output current detection circuit 410 and the overcurrent detection circuit 500.

According to the embodiments described above, the following operational effects can be obtained.

(1) The power conversion device 1000 includes: the inverter circuit 300 including the arms corresponding to a plurality of phases, each arm being configured by connecting the switching element 311 of the upper arm and the switching element 321 of the lower arm in series between the positive side terminal and the negative side terminal of the direct current; the output current detector 400 that detects an AC current output from the connection point between the switching element 311 of the upper arm and the switching element 321 of the lower arm and outputs the detection value Ei; the driver circuit 800 that includes the gate resistor switching circuit 820 that performs switching between the gate resistors Rf1 and Rf2 connected to the gates of each of the switching elements 311 and 321, and drives each of the switching elements 311 and 321 by the drive signal Pw input via the switched gate resistor Rf1 or Rf2; the overcurrent detection circuit 500 that compares the detection value Ei detected by the output current detector 400 with any of a plurality of predetermined overcurrent threshold values VH1, VL1, VH2, and VL2, and outputs the overcurrent detection signal Em in a case where the detection value Ei is more than the overcurrent threshold values VH1, VL1, VH2, and VL2; and the controller 600 that transmits the drive signal Pw to the driver circuit 800, transmits the gate resistor switching signal Rs for performing switching between the gate resistors Rf1 and Rf2 to the driver circuit 800, and transmits the overcurrent threshold-value switching signal Ts for performing switching among the overcurrent threshold values VH1, VL1, VH2, and VL2 to the overcurrent detection circuit 500. The controller 600 sets the overcurrent threshold values VH1, VL1, VH2, and VL2 to a small value by the overcurrent threshold-value switching signal Is in a case where the controller 600 switches to the gate resistor Rf1 having a low resistance value by the gate resistor switching signal Rs. As a result, it is possible to improve the reliability of a power conversion device even in a case where the resistance value of a gate resistor is lowered.

The present invention is not limited to the above-described embodiments, and other forms conceivable within the scope of the technical idea of the present invention are also included within the scope of the present invention as long as the features of the present invention are not impaired. In addition, the above-described embodiments may be combined.

### REFERENCE SIGNS LIST

100 voltage detector
200 capacitor module
300 inverter circuit
310 power module
311, 321 switching element
312, 322 diode
400 output current detector
410 output current detection circuit
500 overcurrent detection circuit
510 threshold-value switching unit
520 comparison unit
600 controller
700 cut-off circuit
800 driver circuit
810 drive circuit
820 gate resistor switching circuit
1000 power conversion device
2000 DC power source
2001 contactor
3000 motor
4000 low-voltage power source
Rn0, Rf1, Rf2 gate resistor
Rs gate resistor switching signal
Pw drive signal
Vdc detection voltage
Ei, Ej detection value
VH1, VL1, VH2, VL2, V1, V2 overcurrent threshold value
Ts overcurrent threshold-value switching signal
Em overcurrent detection signal

1. A power conversion device comprising:
an inverter circuit including arms corresponding to a plurality of phases, each arm being configured by connecting a switching element of an upper arm and a switching element of a lower arm in series between a positive side terminal and a negative side terminal of a direct current;
an output current detector that detects an AC current output from a connection point between the switching element of the upper arm and the switching element of the lower arm and outputs a detection value;
a driver circuit that includes a gate resistor switching circuit that switches a gate resistor connected to a gate of each of the switching elements, and drives each of the switching elements by a drive signal input via the switched gate resistor;
an overcurrent detection circuit that compares the detection value detected by the output current detector with any of a plurality of predetermined overcurrent threshold values, and outputs an overcurrent detection signal in a case where the detection value is more than the overcurrent threshold value; and
a controller that transmits the drive signal to the driver circuit, transmits a gate resistor switching signal for switching the gate resistor to the driver circuit, and transmits an overcurrent threshold-value switching signal for switching the overcurrent threshold value to the overcurrent detection circuit,
wherein the controller sets the overcurrent threshold value to a small value by the overcurrent threshold-value switching signal in a case where the controller switches to the gate resistor having a low resistance value by the gate resistor switching signal.

2. The power conversion device according to claim 1, wherein the overcurrent threshold value is set to a value indicating a current value at which a voltage applied to the switching element does not exceed an allowable value of the switching element, in a case where the switching element is driven by the switched gate resistor.

3. The power conversion device according to claim 1, wherein the overcurrent detection circuit includes a threshold-value switching unit that performs switching between the plurality of overcurrent threshold values by the overcurrent threshold-value switching signal, and a comparison unit that compares the detection value with the overcurrent threshold value.

4. The power conversion device according to claim 3, wherein the plurality of overcurrent threshold values are supplied from a plurality of power sources having different voltage values.

5. The power conversion device according to claim 3, wherein the plurality of overcurrent threshold values are supplied by dividing a voltage from a single power source.

6. The power conversion device according to claim 1, further comprising
a cut-off circuit that cuts off the drive signal transmitted from the controller to the driver circuit,
wherein the cut-off circuit cuts off the drive signal in response to the overcurrent detection signal output from the overcurrent detection circuit.

7. A power conversion device comprising:
an inverter circuit including arms corresponding to a plurality of phases, each arm being configured by connecting a switching element of an upper arm and a switching element of a lower arm in series between a positive side terminal and a negative side terminal of a direct current;
an output current detection circuit that detects a current flowing through each of the switching element and outputs a detection value;
a driver circuit that includes a gate resistor switching circuit that switches a gate resistor connected to a gate of each of the switching elements, and drives the switching elements by a drive signal with the switched gate resistor;
an overcurrent detection circuit that compares the detection value detected by the output current detection circuit with any of a plurality of predetermined overcurrent threshold values, and outputs an overcurrent detection signal in a case where the detection value is more than the overcurrent threshold value; and
a controller that transmits the drive signal to the driver circuit, transmits a gate resistor switching signal for switching the gate resistor to the gate resistor switching circuit, and transmits an overcurrent threshold-value switching signal for switching the overcurrent threshold value to the overcurrent detection circuit,
wherein the controller sets the overcurrent threshold value to a small value by the overcurrent threshold-value switching signal in a case where the controller switches to the gate resistor having a low resistance value by the gate resistor switching signal.

8. The power conversion device according to claim 7, wherein the output current detection circuit detects a current from a current sense terminal that divides the current flowing through the switching element, and outputs the detection value.
